(19) United States
(12) Patent Application Publication
(10) Pub. No.: US 2024/0185311 A1
(43) Pub. Date: Jun. 6, 2024

(54) FUEL CELL POWER SOURCE MANAGEMENT DEVICE AND FUEL CELL POWER SOURCE MANAGEMENT METHOD

(71) Applicant: HONDA MOTOR CO., LTD., Minato-ku, Tokyo (JP)

(72) Inventors: Tatsuya Minagawa, Minato-ku, Tokyo (JP); Akihisa Sato, Minato-ku, Tokyo (JP); Ayato Ito, Minato-ku, Tokyo (JP); Naoki Yamano, Wako-shi, Saitama (JP)

(21) Appl. No.: 18/553,849

(22) PCT Filed: Dec. 28, 2021
(86) PCT No.: PCT/JP2021/048995

§ 371 Date: Oct. 4, 2023

(30) Foreign Application Priority Data
Apr. 9, 2021 (JP) 2021-066272

(51) Int. Cl. G06Q 30/0283; H01M 8/04082

(52) U.S. Cl. CPC G06Q 30/0283; H01M 8/04201

(57) ABSTRACT

A fuel cell power-source management device and a fuel cell power-source management method capable of reducing usage cost of a fuel cell power-source by utilizing boil-off gas. A fuel cell power-source management device manages a fuel cell power-source having a liquid hydrogen tank and a recovery device for boil-off gas generated in the liquid hydrogen tank, and includes: a boil-off gas recovery amount recognition unit that recognizes an amount of boil-off gas recovered by the recovery device; and a usage cost setting unit that sets a usage cost, which is borne by a user of the fuel cell power-source for using the fuel cell power-source, according to the amount of boil-off gas recovered, which amount is recognized by the boil-off gas recovery amount recognition unit.

### TECHNICAL FIELD

The present invention relates to a fuel cell power-source management device and a fuel cell power-source management method.

### BACKGROUND ART

Conventionally, there has been proposed a liquid hydrogen production device that re-liquefies boil-off gas (BOG) generated in a liquid hydrogen tank and re-uses it as liquid hydrogen (see, for example, Patent Literature 1). In addition, a boil-off gas recovery system has been proposed in which boil-off gas generated in a liquefied natural gas storage tank is compressed to separate oil, is then supplied to engines, generators, etc. to be used, and is returned to storage tanks (for example, see Patent Literature 2).

### CITATION LIST

### Patent Literature

### [Patent Literature 1]

Japanese Patent Laid-Open No. 2013-242113

### [Patent Literature 2]

Japanese Patent Laid-Open No. 2018-128038

### SUMMARY OF INVENTION

### Technical Problem

Devices that use liquid hydrogen include fuel cell power-sources, and fuel cell power-sources are deployed in data centers, etc., as backup power-sources in preparation for power outages, for example. Then, the fuel cell power-sources, as described above, desirably utilize the boil-off gas generated in the liquefied hydrogen tank effectively. In addition, in order to promote spread of fuel cell power-sources, it is desirable to reduce usage cost of fuel cell power-sources.

The present invention has been made in view of this background, and an object of the present invention is to provide a fuel cell power-source management device and a fuel cell power-source management method capable of utilizing boil-off gas to reduce usage cost of a fuel cell power-source.

### Solution to Problem

This specification includes all the contents of Japanese Patent Application No. 2021-066272 filed on Apr. 9, 2021.

A first aspect for achieving the above object is a fuel cell power-source management device that manages a fuel cell power-source having a liquid hydrogen tank and a recovery device for boil-off gas generated in the liquid hydrogen tank, the fuel cell power-source management device including: a boil-off gas recovery amount recognition unit that recognizes an amount of boil-off gas recovered by the recovery device; and a usage cost setting unit that sets a usage cost according to an amount of recovered boil-off gas, the usage cost being borne by a user of the fuel cell power-source for using the fuel cell power-source, the amount being recognized by the boil-off gas recovery amount recognition unit.

The fuel cell power-source management device may include a boil-off gas utilization profit recognition unit that recognizes boil-off gas utilization profit that is profit obtained by utilizing boil-off gas recovered by the recovery device, wherein the usage cost setting unit sets the usage cost based on the boil-off gas utilization profit recognized by the boil-off gas utilization profit recognition unit.

The fuel cell power-source management device may be configured so that the boil-off gas utilization profit recognition unit recognizes power, used for maintenance of the fuel cell power-source, as the boil-off gas utilization profit, the power being generated by utilizing boil-off gas recovered by the recovery device.

The fuel cell power-source management device may be configured so that the boil-off gas utilization profit recognition unit recognizes profit obtained by selling power as the boil-off gas utilization profit, the power being obtained by subtracting power used for maintenance of the fuel cell power-source from power generated by utilizing boil-off gas recovered by the recovery device.

The fuel cell power-source management device may include: a market price information acquisition unit that acquires market price information of boil-off gas or market price information of an object to be produced from boil-off gas; and a boil-off gas sale information provision unit that provides boil-off gas sale information to the user, the boil-off gas sale information including a recovery amount of boil-off gas and a market price of boil-off gas or the object to be produced, the recovery amount being recognized by the boil-off gas recovery amount recognition unit, the market price of boil-off gas or the object to be produced being recognized from the market price information.

A second aspect for achieving the above object is a fuel cell power-source management method executed by a computer for managing a fuel cell power-source having a liquid hydrogen tank and a recovery device for boil-off gas generated in the liquid hydrogen tank, the fuel cell power-source management method including: a boil-off gas recovery amount recognition step that recognizes an amount of boil-off gas recovered by the recovery device; and a usage cost setting step that sets a usage cost according to an amount of recovered boil-off gas, the usage cost being borne by a user of the fuel cell power-source for using the fuel cell power-source, the amount being recognized by the boil-off gas recovery amount recognition step.

### Advantageous Effect of Invention

The above fuel cell power-source management device makes it possible to utilize boil-off gas to reduce the usage cost of the fuel cell power-source.

### BRIEF DESCRIPTION OF DRAWINGS

FIG. 1 is an explanatory diagram showing an aspect of supporting utilization of boil-off gas with a fuel cell power-source management device.

FIG. 2 is an explanatory diagram of a configuration of the fuel cell power-source management device.

FIG. 3 is a first flowchart of boil-off gas utilization support processing with the fuel cell power-source management device.

FIG. 4 is a second flowchart of boil-off gas utilization support processing with the fuel cell power-source management device.

### DESCRIPTION OF EMBODIMENTS

[1. Aspect of Support for Utilization of Boil-Off Gas with Fuel Cell Power-Source Management Device]

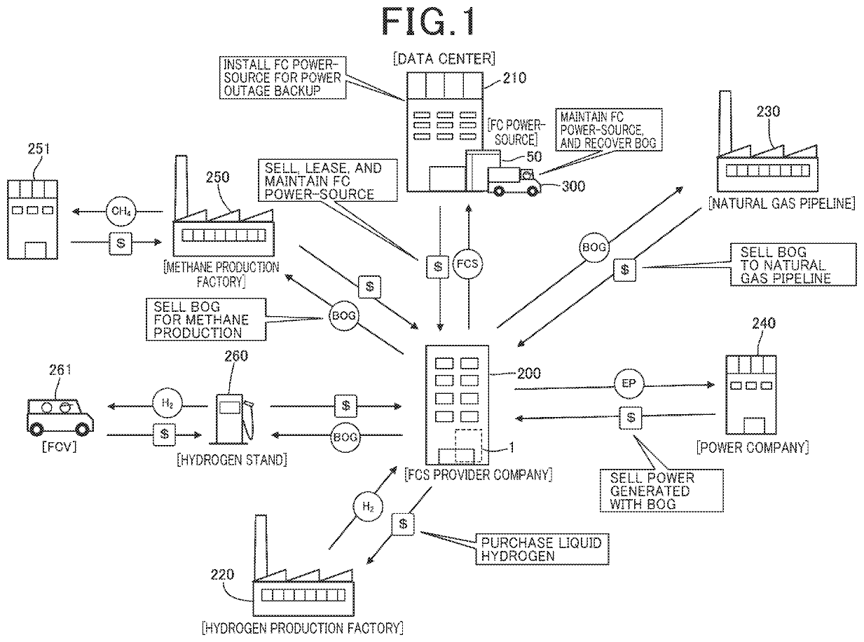

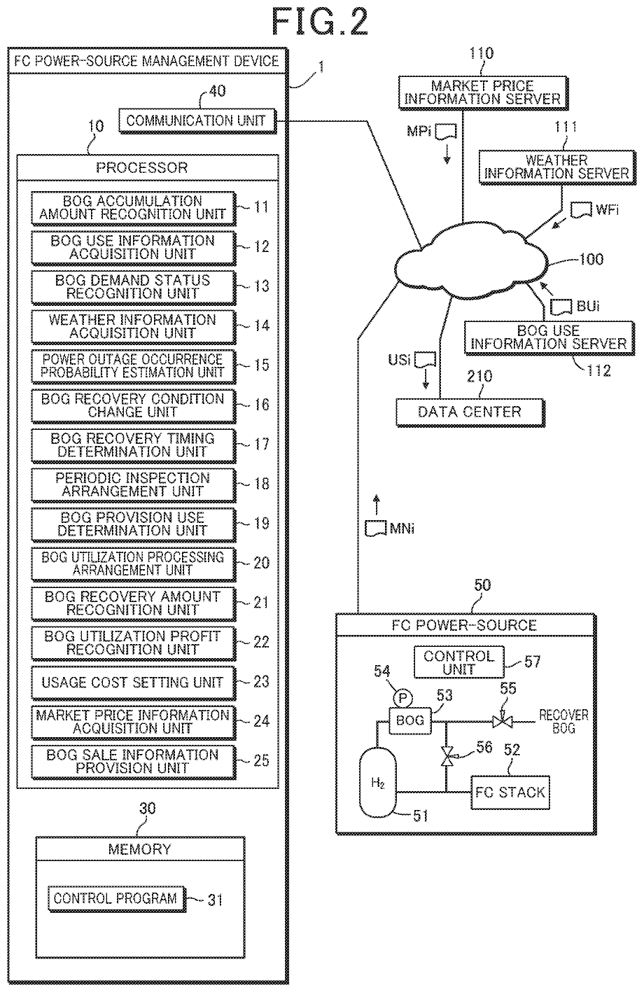

With reference to FIGS. 1 and 2, the following describes an aspect of support for utilization of boil-off gas generated by a fuel cell power-source 50, which support is implemented by a fuel cell power-source. Hereinafter, the fuel cell power-source management device 1 is referred to as an FC (fuel cell) power-source management device 1, the fuel cell power-source 50 is referred to as an FC power-source 50, and the boil-off gas is referred to as BOG.

As shown in FIG. 2, the FC power-source 50 includes a liquid hydrogen tank 51 filled with liquid hydrogen, an FC stack 52 that generates power through redox reaction between the hydrogen supplied from the liquid hydrogen tank 51 and oxygen in the air, and a BOG tank 53 for accumulating BOG generated from the liquid hydrogen tank 51. Furthermore, the FC power-source 50 includes a BOG pressure sensor 54 for detecting the pressure in the BOG tank 53, a BOG recirculation valve 56 for switching between supply and cutoff of BOG from the BOG tank 53 to the FC stack 52, and a BOG recovery valve 55 for recovering BOG accumulated in the BOG tank 53. The BOG tank 53 and the BOG recovery valve 55 constitute a BOG recovery device of the present disclosure.

The FC power-source management device 1 is installed in an FCS (fuel cell system) provider company 200 that sells, leases, and maintains the FC power-source 50, sells liquid hydrogen, etc. FIG. 1 shows an example in which the FCS provider company 200 purchases liquid hydrogen from a hydrogen production company 220. In addition, FIG. 1 shows a status in which the FCS provider company 200 provides a data center 210 with the FC power-source 50 by lease and supports the operation of the FC power-source 50. The data center 210 has an FC power-source 50 as a backup power-source in a power outage occurrence.

The FCS provider company 200 implements regular maintenance of the FC power-source 50 and service of recovering and utilizing the BOG generated in the liquid hydrogen tank 51 of the FC power-source 50 and accumulated in the BOG tank 53 thereof. The recovery of BOG may be performed by a service vehicle 300, or may be performed by connecting the provision destination and the FC power-source 50 through piping. The data center 210 pays the FCS provider company 200 the lease fee and maintenance fee for the FC power-source 50. The FC power-source management device 1 recovers and utilizes the BOG generated by the FC power-source 50, thereby executing processing of reducing the usage cost borne by the data center 210 in deploying the FC power-source 50.

The FCS provider company 200 provides BOG for the following first to seventh uses, thereby obtaining benefits such as reduction in power cost in the data center 210 and gain on the sale of BOG.
First use . . . supplying BOG to the FC stack 52 to generate power and maintaining the FC power-source 50 using the generated power.
Second use . . . supplying BOG to the FC stack 52 to generate power, and using the generated power to operate the data center 210 equipment.
Third use . . . using BOG for fuel for the FCV (fuel cell vehicle) operated in the data center 210.
Fourth use . . . selling BOG to a natural gas pipeline 230.
Fifth use . . . supplying BOG to the FC stack 52 to generate power, and selling the generated power to a power company 240 (power selling).
Sixth use . . . selling BOG to a methane production company 250. The methane production company 250 reacts the purchased BOG with other substances such as CO₂ to produce methane gas and sells it to other production company 251, etc. Here, the substance generated from BOG may be a substance other than methane gas.
Seventh use . . . selling BOG to a stand. The sold BOG is to be sold to FCV 261, etc.

Provision of BOG for the above first to third uses allows a portion of the power used in the data center to be covered by BOG power generation. This makes it possible to reduce the power usage fee to be paid to the power company by the data center 210. Then, the reduced power usage fee can be used for the payment of the usage fee of the FC power-source 50 (lease fee, maintenance fee, purchase cost of liquid hydrogen, etc.), to reduce the usage cost of the FC power-source 50, promoting spread of the FC power-source 50.

Also, when BOG is provided for the fourth to seventh uses, the FC power-source management device 1 reduces the usage fee of the FC power-source 50 according to the profit from the sale of the BOG. This makes it possible to reduce the usage cost of the FC power-source 50 to promote spread of the FC power-source 50. The FC power-source management device 1 also executes processing for efficiently recovering BOG and processing for determining an appropriate use for BOG to be provided.

### [Configuration of FC Power-Source Management Device]

A configuration of the FC power-source management device 1 will be described with reference to FIG. 2. The FC power-source management device 1 is a computer system including a processor 10, a memory 30, and a communication unit 40. The processor 10 corresponds to a computer of the present disclosure.

The FC power-source management device 1 causes the communication unit 40 to communicate, via a communication network 100, with a FC power-source 50, a market price information server 110, a weather information server 111, a BOG use information server 112, and a data center 210. The control unit 57 of the FC power-source 50 transmits monitor information MNi indicating the operating status of the FC power-source 50 to the FC power-source management device 1. The monitor information MNi includes the pressure in the BOG tank 53 detected by the BOG pressure sensor 54 and the provision destination and provision amount of the recovered BOG.

The market price information server 110 transmits, to the FC power-source management device 1, market price information MPi indicating market prices (transaction prices) of BOG and power when BOG is provided and sold for the fourth to seventh uses. The weather information server 111 transmits, to the FC power-source management device 1, weather information WFi indicating a weather forecast for a predetermined period ahead. The BOG use information server 112 transmits, to the FC power-source management device 1, BOG use information BUi indicating the demand status of the first to seventh usages and the consumable amount of BOG in the first to seventh usages. The FC power-source management device 1 transmits BOG utilization information USi indicating the BOG utilization status to the data center 210.

The processor 10 reads and executes a control program 31 stored in the memory 30 to function as a BOG accumulation amount recognition unit 11, a BOG use information acquisition unit 12, a BOG demand status recognition unit 13, a weather information acquisition unit 14, a power outage occurrence probability estimation unit 15, a BOG recovery condition change unit 16, a BOG recovery timing determination unit 17, a periodic inspection arrangement unit 18, a BOG provision use determination unit 19, a BOG utilization processing arrangement unit 20, a BOG recovery amount recognition unit (boil-off gas recovery amount recognition unit) 21, a BOG utilization profit recognition unit (boil-off gas utilization profit recognition unit) 22, a usage cost setting unit 23, a market price information acquisition unit 24 and a BOG sale information provision unit (boil-off gas sale information provision unit) 25.

The BOG accumulation amount recognition unit 11 receives the monitor information MNi transmitted from the FC power-source 50, to recognize the internal pressure of the BOG tank 53 detected by the BOG pressure sensor 54. Based on the internal pressure of the BOG tank 53, the BOG accumulation amount recognition unit 11 recognizes the amount of BOG accumulated in the BOG tank 53. Note that the amount of BOG gas accumulated in the BOG tank 53 may be recognized by detecting the flow rate of the BOG gas flowing into the BOG tank 53 from the liquid hydrogen tank 51 instead of the internal pressure of the BOG tank 53.

The BOG use information acquisition unit 12 receives the BOG use information BUi transmitted from the BOG use information server 112, to recognize uses in which BOG can be utilized. In the present embodiment, the BOG use information acquisition unit 12 recognizes the first to seventh uses as uses in which BOG can be utilized. The BOG demand status recognition unit 13 receives the BOG use information BUi transmitted from the BOG use information server 112, to recognize the demand for BOG (amount of BOG needed) in the first to seventh uses above.

The weather information acquisition unit 14 receives weather information WFi transmitted from the weather information server 111, to acquire weather forecast information for a predetermined period (for example, one week) ahead in the predetermined area where the FC power-source 50 is installed. Based on the information of the weather forecast for the predetermined period ahead acquired by the weather information acquisition unit 14, the power outage occurrence probability estimation unit 15 predicts the occurrence of a lightning strike, etc. and estimates the power outage occurrence probability within the predetermined period ahead in the predetermined area.

Based on the power outage occurrence probability estimated by the power outage occurrence probability estimation unit 15, the BOG recovery condition change unit 16 changes conditions for determining the timing of recovering BOG from the FC power-source 50. In the present embodiment, the conditions for determining the timing of recovering BOG are set to the following first condition and second condition.

First condition . . . the accumulated amount of BOG gas in the BOG tank 53 is equal to or greater than the first determination amount.

Second condition . . . the BOG demand amount in any of the above first to seventh uses is equal to or greater than the second determination amount. Note that the second condition may be set so that the total BOG demand amount for the first to seventh uses is equal to or greater than the second determination amount.

Then, when the power outage occurrence probability is equal to or lower than the first predetermined value and the possibility of power outage occurrence is low, the BOG recovery condition change unit 16 relaxes the conditions for determining the BOG recovery timing. In other words, the first determination amount under the first condition and the second determination amount under the second condition are decreased. This then makes it possible to actively recover BOG in a period when the power outage occurrence probability is low.

Further, the BOG recovery condition change unit 16 prohibits the determination of the BOG recovery timing when the power outage occurrence probability is equal to or higher than a second predetermined value higher than the first predetermined value and the possibility of power outage occurrence is high. This makes it possible to prohibit recovery of BOG to secure the accumulated amount of BOG when there is a high possibility with which the FC power-source 50 should be operated due to a power outage occurrence. This thereby makes it possible to use the BOG to cause the FC power-source 50 to generate power in a power outage occurrence.

The BOG recovery timing determination unit 17 determines the time when the first condition or the second condition is satisfied as the BOG recovery timing. The periodic inspection arrangement unit 18 determines the timing of periodic inspection of the FC power-source 50 in synchronization with the recovery timing determined by the BOG recovery timing determination unit 17. Based on the market price information MPi, the market price information acquisition unit 24 recognizes the market price for each use of BOG.

The BOG provision use determination unit 19 determines the use for which the BOG is provided based on the demand status for the first to seventh uses recognized by the BOG demand status recognition unit 13 and the market price for each use of BOG recognized by the market price information acquisition unit 24. Here, priority may be set for the type of use, demand status, market price, etc., which are elements for determining the use for which BOG is to be provided, to determine the use for which BOG is to be provided. The BOG utilization processing arrangement unit 20 arranges provision of BOG for the use determined by the BOG provision use determination unit 19.

The BOG recovery amount recognition unit 21 recognizes the recovery amount of BOG recovered from the FC power-source 50 and the provision destination based on the monitor information MNi. The BOG utilization profit recognition unit 22 recognizes the profit obtained by providing BOG based on the BOG recovery amount and the provision destination recognized by the BOG recovery amount recognition unit 21. The usage cost setting unit 23 reduces the usage fee of the FC power-source 50 (usage cost of the FC power-source 50) based on the profit recognized by the BOG utilization profit recognition unit 22.

The BOG sale information provision unit 25 transmits, to the data center 210, BOG utilization information USi (including boil-off gas sale information of the present disclosure) indicating the amount of BOG provided and the profit obtained from the sale, regarding the uses for which BOG has been provided. The administrator of the data center 210 can recognize the BOG utilization information USi to recognize the utilization status of the BOG, and can recognize that the usage cost of the FC power-source 50 is reduced by utilizing the BOG.

### [3. BOG Utilization Support Processing]

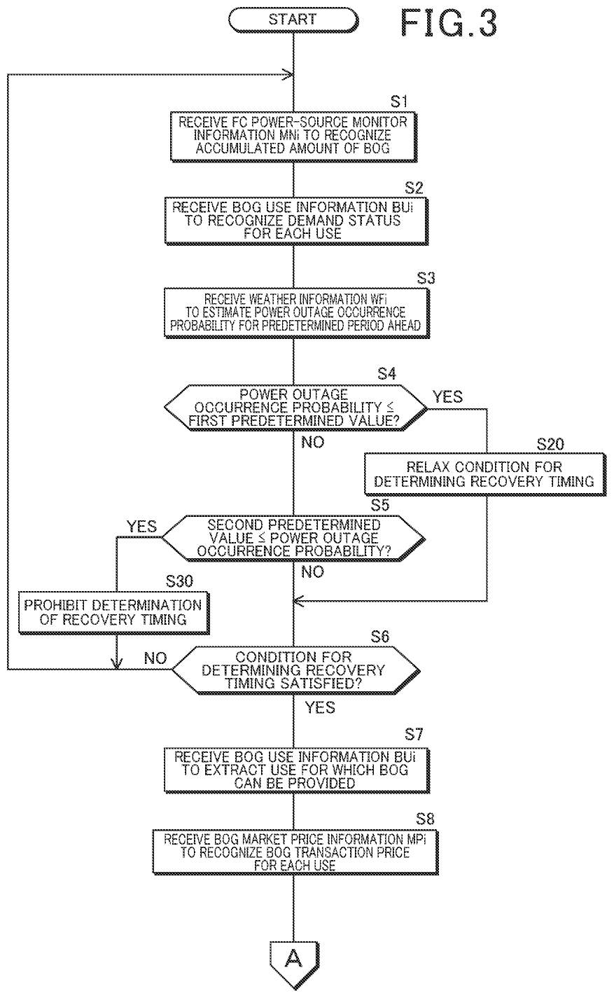

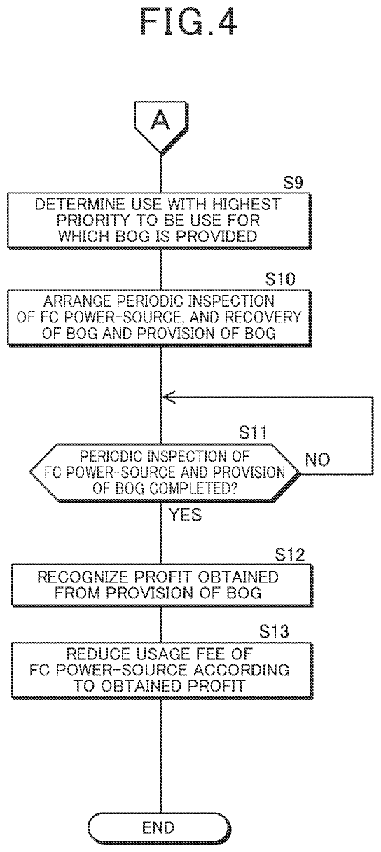

BOG utilization support processing executed by the FC power-source management device 1 will be described according to flowcharts shown in FIGS. 3 to 4. In step S1 in FIG. 3, the BOG accumulation amount recognition unit 11 recognizes the accumulated amount of BOG in the BOG tank 53 based on the monitor information MNi transmitted from the FC power-source 50.

In the next step S2, the BOG demand status recognition unit 13 receives the BOG use information BUi transmitted from the BOG use information server 112, and recognizes the demand status of the first to seventh uses based on the BOG use information BUi. In subsequent step S3, the weather information acquisition unit 14 receives the weather information WFi from the weather information server 111, and the power outage occurrence probability estimation unit 15 estimates the power outage probability based on the weather information WFi.

In the next step S4, the BOG recovery condition change unit 16 determines whether the power outage occurrence probability is equal to or lower than the first predetermined value. Then, when the power outage occurrence probability is equal to or lower than the first predetermined value, the BOG recovery condition change unit 16 advances the processing to step S20, and relaxes the conditions for determining the BOG recovery timing as described above, and advances the processing to step S6. Contrarily, when the power outage occurrence probability is higher than the first predetermined value, the BOG recovery condition change unit 16 advances the processing to step S5.

In step S5, the BOG recovery condition change unit 16 determines whether the power outage occurrence probability is equal to or higher than the second predetermined value. Then, when the power outage occurrence probability is equal to or higher than the second predetermined value, the BOG recovery condition change unit 16 advances the processing to step S30 to prohibit determination of the BOG recovery timing, and then advances the processing to step S1. Contrarily, when the power outage occurrence probability is lower than the second predetermined value, the BOG recovery condition change unit 16 advances the processing to step S6.

In step S6, the BOG recovery timing determination unit 17 determines whether a condition for determining the BOG recovery timing is satisfied (whether the first condition or the second condition is satisfied). Then, the BOG recovery timing determination unit 17 advances the processing to step S6 when the condition for determining the BOG recovery timing is satisfied, and advances the processing to step S1 when the condition for determining the BOG recovery timing is not satisfied.

In step S7, the BOG demand status recognition unit 13 receives the BOG use information BUi transmitted from the BOG use information server 112, and recognizes the use for which BOG can be provided based on the BOG use information BUi. In the subsequent step S8, the market price information acquisition unit 24 receives the market price information MPi transmitted from the market price information server 110, and recognizes the transaction price of BOG for each use based on the market price information MPi.

In the next step S9 in FIG. 4, the BOG provision use determination unit 19 determines use with the highest priority, which is set from the BOG demand status and the BOG transaction price among the uses extracted in step S7, to be the use for which BOG is to be provided. In the subsequent step S10, the periodic inspection arrangement unit 18 arranges periodic inspection of the FC power-source 50, and the BOG utilization processing arrangement unit 20 arranges provision of BOG for the use determined by the BOG provision use determination unit 19. As a result, the BOG can be recovered efficiently in synchronization with periodic inspection of the FC power-source 50.

In the next step S11, the BOG utilization profit recognition unit 22 determines whether the periodic inspection of the FC power-source 50 and the provision of BOG are completed, and advances the processing to step S12 when the periodic inspection of the FC power-source 50 and the provision of BOG are completed. In step S12, the BOG utilization profit recognition unit 22 recognizes the profit obtained by providing the BOG. In the next step S13, the usage cost setting unit 23 reduces the usage fee of the FC power-source 50 according to the profit obtained by providing the BOG.

### 4. Other Embodiments

In the above embodiment, the FCS provider company 200 provides the user (data center 210) with the FC power-source 50 under a lease contract. As another embodiment, the FCS provider company 200 may provide the FC power-source 50 by selling out. In the case of selling out, the maintenance cost of the FC power-source 50, etc. becomes the usage cost.

Alternatively, the FCS provider company 200 may sell liquid hydrogen to a user of FC power-source. In this case, there may be a scheme such that the purchase cost of the liquid hydrogen is determined to be the usage cost of the FC power-source 50 and the usage cost of the FC power-source 50 is reduced by discounting the selling price of the liquid hydrogen according to the provision of BOG.

In the above-described embodiment, the first to seventh uses are exemplified as uses for which BOG are utilized, but any use is allowed as long as the provision of BOG provides the user of the FC power-source 50 with some benefit.

In the above embodiment, an example is shown in which the FC power-source management device 1 is installed in the FCS provider company 200. However, the FC power-source management device 1 may be provided in the FC power-source 50, or may be installed in the data center 210 (deployment location of the FC power-source 50). Alternatively, the FC power-source management device 1 may be composed of a server other than the servers of FCS provider company 200 and the data center 210.

Note that FIG. 2 is a schematic diagram showing the configuration of the FC power-source management device 1 segmented according to the main matters to be processed for facilitating understanding of the invention of the present application, and the FC power-source management device may also be configured based on other segmentations. The processing of each component may be executed by one hardware unit, or may be executed by a plurality of hardware units. Further, the processing of each component according to the flowcharts shown in FIGS. 3 and 4 may be executed by one program or may be executed by a plurality of programs.

In the above embodiment, the processing executed by the BOG recovery amount recognition unit 21 corresponds to a boil-off gas recovery amount recognition step in the fuel cell power-source management method of the present disclosure, and the processing executed by the usage cost setting unit 23 corresponds to a usage cost setting step in the fuel cell power-source management method of the present disclosure.

### 5. Configurations Supported by Above Embodiments

The above embodiments are specific examples of the following configurations.

(Configuration 1) A fuel cell power-source management device that manages a fuel cell power-source having a liquid hydrogen tank and a recovery device for boil-off gas generated in the liquid hydrogen tank, the fuel cell power-source management device including: a boil-off gas recovery amount recognition unit that recognizes an amount of boil-off gas recovered by the recovery device; and a usage cost setting unit that sets a usage cost according to an amount of recovered boil-off gas, the usage cost being borne by a user of the fuel cell power-source for using the fuel cell power-source, the amount being recognized by the boil-off gas recovery amount recognition unit.

The fuel cell power-source management device of configuration 1 makes it possible to utilize boil-off gas to reduce the usage cost of the fuel cell power-source.

(Configuration 2) The fuel cell power-source management device according to configuration 1, further including a boil-off gas utilization profit recognition unit that recognizes boil-off gas utilization profit that is profit obtained by utilizing boil-off gas recovered by the recovery device, wherein the usage cost setting unit sets the usage cost based on the boil-off gas utilization profit recognized by the boil-off gas utilization profit recognition unit.

The fuel cell power-source management device of configuration 2 makes it possible to set the usage cost of the fuel cell power-source based on the profit obtained by utilization of boil-off gas to encourage utilization of boil-off gas.

(Configuration 3) The fuel cell power-source management device according to configuration 2, wherein the boil-off gas utilization profit recognition unit recognizes power, used for maintenance of the fuel cell power-source, as the boil-off gas utilization profit, the power being generated by utilizing boil-off gas recovered by the recovery device.

The fuel cell power-source management device of configuration 3 makes it possible to use the power generated by utilizing boil-off gas for maintenance of fuel cell power-sources to reduce the maintenance cost for the fuel cell power-source and thereby promote spread of fuel cell power-sources.

(Configuration 4) The fuel cell power-source management device according to configuration 2, wherein the boil-off gas utilization profit recognition unit recognizes profit obtained by selling power as the boil-off gas utilization profit, the power being obtained by subtracting power used for maintenance of the fuel cell power-source from power generated by utilizing boil-off gas recovered by the recovery device.

The fuel cell power-source management device of configuration 4 makes it possible to sell power generated by utilizing boil-off gas to reduce the usage cost of the fuel cell power-source and thereby promote spread of fuel cell power-sources.

(Configuration 5) The fuel cell power-source management device according to any one configuration of configurations 1 to 4, further including: a market price information acquisition unit that acquires market price information of boil-off gas or market price information of an object to be produced from boil-off gas; and a boil-off gas sale information provision unit that provides boil-off gas sale information to the user, the boil-off gas sale information including a recovery amount of boil-off gas and a market price of boil-off gas or the object to be produced, the recovery amount being recognized by the boil-off gas recovery amount recognition unit, the market price of boil-off gas or the object to be produced being recognized from the market price information.

The fuel cell power-source management device of configuration 5 makes it possible to provide the boil-off gas sale information to the user to make the user recognize that the usage cost of the fuel cell power-source is reduced by utilizing the boil-off gas. The object to be produced from boil-off gas is, for example, methane, and may be a substance other than methane.

(Configuration 6) A fuel cell power-source management method executed by a computer for managing a fuel cell power-source having a liquid hydrogen tank and a recovery device for boil-off gas generated in the liquid hydrogen tank, the fuel cell power-source management method including: a boil-off gas recovery amount recognition step that recognizes an amount of boil-off gas recovered by the recovery device; and a usage cost setting step that sets a usage cost according to an amount of recovered boil-off gas, the usage cost being borne by a user of the fuel cell power-source for using the fuel cell power-source, the amount being recognized by the boil-off gas recovery amount recognition step.

Execution of the fuel cell power-source management method of configuration 6 by a computer can provide the same actions and effects as the fuel cell power-source management device of configuration 1.

### INDUSTRIAL APPLICABILITY

The fuel cell power-source management device and the fuel cell power-source management method of the present disclosure can recover boil-off gas generated in a liquid hydrogen tank of a fuel cell power-source and can utilize the recovered boil-off gas, to be applied to uses for reducing the usage cost of the fuel cell power-source.

### REFERENCE SIGNS LIST

1 . . . fuel cell power-source (FC power-source) management device, 10 . . . processor, 11 . . . BOG accumulation amount recognition unit, 12 . . . BOG use information acquisition unit, 13 . . . BOG demand status recognition unit, 14 . . . weather information acquisition unit, 15 . . . power outage occurrence probability estimation unit, 16 . . . BOG recovery condition change unit, 17 . . . BOG recovery timing determination unit, 18 . . . periodic inspection arrangement unit, 19 . . . BOG provision use determination unit, 20 . . . BOG utilization processing arrangement unit, 21 . . . BOG recovery amount recognition unit, 22 . . . BOG utilization profit recognition unit, 23 . . . usage cost setting unit, 24 . . . market price information acquisition unit, 25 . . . BOG sale information provision unit, 30 . . . memory, 31 . . . control program, 50 . . . FC power-source, 51 . . . liquid hydrogen tank, 52 . . . FC stack, 53 . . . BOG tank, 100 . . . communication network, 110 . . . market price information server, 111 . . . weather information server, 112 . . . BOG use information server.

1. A fuel cell power-source management device that manages a fuel cell power-source having a liquid hydrogen tank and a recovery device for boil-off gas generated in the liquid hydrogen tank, the fuel cell power-source management device characterized by comprising:
a boil-off gas recovery amount recognition unit that recognizes an amount of boil-off gas recovered by the recovery device; and
a usage cost setting unit that sets a usage cost according to an amount of recovered boil-off gas, the usage cost being borne by a user of the fuel cell power-source for using the fuel cell power-source, the amount being recognized by the boil-off gas recovery amount recognition unit.

2. The fuel cell power-source management device according to claim 1, further comprising a boil-off gas utilization profit recognition unit that recognizes boil-off gas utilization profit that is profit obtained by utilizing boil-off gas recovered by the recovery device,
wherein the usage cost setting unit sets the usage cost based on the boil-off gas utilization profit recognized by the boil-off gas utilization profit recognition unit.

3. The fuel cell power-source management device according to claim 2, wherein the boil-off gas utilization profit recognition unit recognizes power, used for maintenance of the fuel cell power-source, as the boil-off gas utilization profit, the power being generated by utilizing boil-off gas recovered by the recovery device.

4. The fuel cell power-source management device according to claim 2, wherein the boil-off gas utilization profit recognition unit recognizes profit obtained by selling power as the boil-off gas utilization profit, the power being obtained by subtracting power used for maintenance of the fuel cell power-source from power generated by utilizing boil-off gas recovered by the recovery device.

5. The fuel cell power-source management device according to claim 1, further comprising:
a market price information acquisition unit that acquires market price information of boil-off gas or market price information of an object to be produced from boil-off gas; and
a boil-off gas sale information provision unit that provides boil-off gas sale information to the user, the boil-off gas sale information including a recovery amount of boil-off gas and a market price of boil-off gas or the object to be produced, the recovery amount being recognized by the boil-off gas recovery amount recognition unit, the market price of boil-off gas or the object to be produced being recognized from the market price information.

6. A fuel cell power-source management method executed by a computer for managing a fuel cell power-source having a liquid hydrogen tank and a recovery device for boil-off gas generated in the liquid hydrogen tank, the fuel cell power-source management method characterized by comprising:
a boil-off gas recovery amount recognition step that recognizes an amount of boil-off gas recovered by the recovery device; and
a usage cost setting step that sets a usage cost according to an amount of recovered boil-off gas, the usage cost being borne by a user of the fuel cell power-source for using the fuel cell power-source, the amount being recognized by the boil-off gas recovery amount recognition step.
